(19) United States
(12) Patent Application Publication
(10) Pub. No.: US 2014/0297575 A1
(43) Pub. Date: Oct. 2, 2014

(54) NAVIGATING THROUGH GEOLOCATED IMAGERY SPANNING SPACE AND TIME

(71) Applicant: GOOGLE INC., Mountain View, CA (US)

(72) Inventors: Evan Rapoport, Los Altos, CA (US); Allen Hutchison, San Jose, CA (US); Kei Kawai, Mountain View, CA (US); Luc Vincent, Palo Alto, CA (US)

(73) Assignee: GOOGLE INC., Mountain View, CA (US)

(21) Appl. No.: 13/854,314

(22) Filed: Apr. 1, 2013

(51) Int. Cl. G06N 5/04

(52) U.S. Cl. CPC G06N 5/04
USPC 706/46

(57) ABSTRACT

Systems and methods of the present disclosure provide techniques for providing user-specified ways of navigating through real-world three-dimensional geographic imagery that spans space and time. An exemplary method includes identifying a plurality of images depicting a geographic location at street level. The images are captured at the geographic location over a span of time. Using a processor, image data is associated with the plurality of images. The image data includes information representing positional data and a time dimension related to the plurality of images. Using the processor, a user's navigational intent to move back and forward through the time dimension is predicted based on a navigational signal. The exemplary method further includes selecting a set of images from the plurality of images based on the image data and the predicted navigational intent. The set of images depict conditions at the geolocation for one or more time periods.

### BACKGROUND

Various services are capable of displaying street level images of geographic locations. Typically, the images are received from different sources and grouped by locations where the images were taken. These images may include street level photographs of real world locations, which may allow users to view these locations from a person's perspective at ground level. However, using traditional navigation controls, such as a mouse or a keyboard, may present challenges when users try to move around a 2D representation (e.g., images displayed on a monitor) of a real-world 3D space. Moreover, when a fourth dimension, time, is added to this, the navigation challenges become even more challenging.

Some services such as Google Earth are capable of allowing users to move through time in order to see older satellite imagery, but these satellite images are from overhead as opposed to a three dimensional street level view of a location.

### BRIEF SUMMARY

Aspects of this disclosure may be advantageous for providing user-specified ways of navigating through real-world three-dimensional geographic imagery that spans space and time. By tagging a set of street level images with a type of a time epoch or label representing a time dimension associated with the images, the techniques disclosed herein may determine the user's navigational intent to move back or forward through this time dimension. Yet further, through a number of signals, the user's navigational intent can also be predicted.

One aspect of the present technology provides a method. The method includes identifying a plurality of images depicting a geographic location at street level. The images are captured at the geographic location over a span of time. Using a processor, image data may be associated with the plurality of images. The image data includes information representing positional data and a time dimension related to the plurality of images. By using the processor, a user's navigational intent to move back and forward through the time dimension may be predicted based on a navigational signal being at least one of: a search query performed by the user, identifying a current location of the user or the user's search history. The method further includes selecting a set of images from the plurality of images based on the image data and the predicted navigational intent. The set of images depict conditions at the geolocation for one or more time periods.

In one example, the positional data associated with the set of images overlap with each other. In another example, the method also includes providing, to a display of a client device, an indicator of available time periods for which images from the set of images are available for the geographic location. In this regard, a request for images associated with the geographic location for at least one of the available time periods may be received. In response to the request, the images for the available time periods may be provided to the client device for display. In yet another example, associating a time dimension with the plurality of images includes identifying visual features disposed in the plurality of images related to a given time period.

Another aspect of the present technology provides a non-transitory computer readable medium including instructions that, when executed by a processor, cause the processor to perform a method. The method includes identifying a plurality of images depicting a geographic location at street level. The images are captured at the geographic location over a span of time. Using a processor, image data may be associated with the plurality of images. The image data includes information representing positional data and a time dimension related to the plurality of images. By using the processor, a user's navigational intent to move back and forward through the time dimension may be predicted based on a navigational signal being at least one of: a search query performed by the user, a current location of the user or the user's search history. The method further includes selecting a set of images from the plurality of images based on the image data and the predicted navigational intent. The set of images depict conditions at the geolocation for one or more time periods.

Yet another aspect of the present technology provides a system that includes a memory for storing images and image data and a processor coupled to the memory. The processor may be configured to identify a plurality of images depicting a geographical location at street level. The images are captured at the geographical location over a span of time. Image data may be associated with the plurality of images. The image data includes information representing positional data and a time dimension related to the plurality of images. A user's navigational intent to move back and forward through the time dimension may be predicted based on a navigational signal being at least one of: a search query performed by the user, a current location of the user or the user's search history. Yet further, a set of images from the plurality of images may be selected based on the image data and the predicted navigational intent. The set of images depict conditions at the geolocation for one or more time periods.

### BRIEF DESCRIPTION OF THE DRAWINGS

FIG. 1 is a functional diagram of image data including an example street level image in accordance with aspects of the disclosure.

FIG. 2 is a block diagram of a system in accordance with aspects the present disclosure.

FIG. 3 is a functional diagram of a location of a street level image and locations other street level images within varying ranges in accordance with aspects of the disclosure.

FIG. 4 is an illustration of a street level image including an example of an interface in accordance with aspects of the disclosure.

FIG. 5 is a flow diagram depicting an example of a method incorporating navigational services in accordance with aspects of the disclosure.

FIG. 6 is a flow diagram depicting an example of a method for predicting a navigational intent in accordance with aspects of the disclosure.

### DETAILED DESCRIPTION

Aspects, features and advantages of this disclosure will be appreciated when considered with reference to the following description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

The subject matter of the present disclosure describes systems and methods for navigating through real-world geolocated imagery that span space and time. In particular, when a user indicates an intent to navigate through images of a geolocation (e.g., a real-world physical location) as if driving along city streets, such as in “Street View” on Google Maps, the techniques disclosed herein may determine the user's intent to move back or forward in time. Yet further, through a number of signals, the user's navigational intent can also be predicted. By tagging a set of street level images with a type of time epoch (e.g., a label indicating distinctive features related to a specific time period), it may be possible to detect whether users would benefit from a 4D navigation or just a 3D navigation of the images.

For situations in which the subject matter described herein collects information about users, or may make use of user-related information, the users may be provided with an opportunity to control whether programs or features collect user information (e.g., information about a user's social network, social actions or activities, profession, preferences or a user's current location), or to control whether and/or how to receive information that may be of interest to the user. In addition, certain data may be treated in one or more ways before it is stored or used, so that personally identifiable information is removed. For example, a user's identity may be treated so that no personally identifiable information can be determined for the user, or a user's current and historical geographic location may be generalized where location information is obtained (such as to a city, ZIP code or state level), so that a particular location of a user cannot be determined. A user may also be provided with the opportunity to decide whether, and to control how, such information (such as search and location history) is used and stored on a user's device and by servers with which the device communicates.

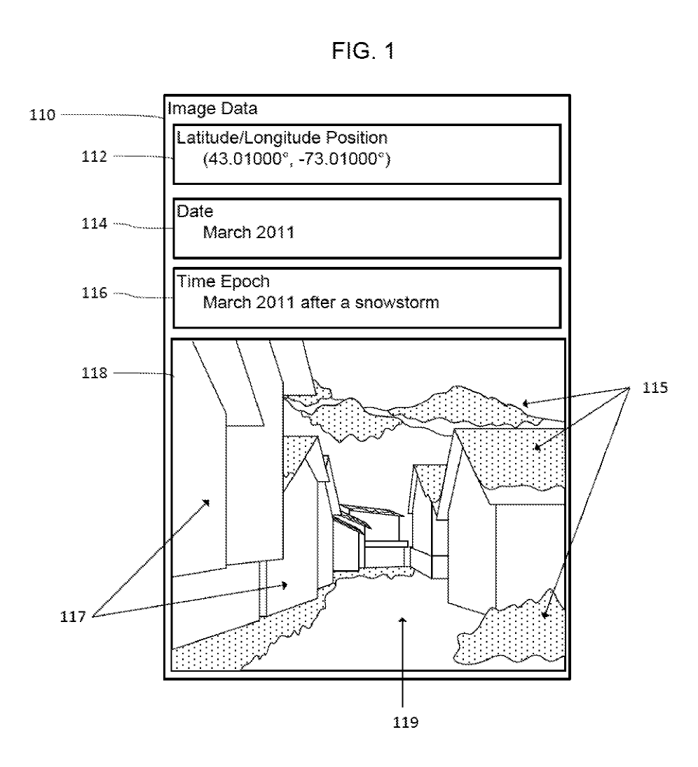

FIG. 1 is a functional diagram of image data 110 including an example street level image 118. A client device may display street level images of geolocations to users. The street level images may include a number of objects, such as a street 119, buildings 117 and mountainous terrain, as well as a related weather condition (e.g., snow 115) at the geographic location. The images may be been captured at the location, for example, by cameras or image capturing devices.

Street level images can be captured in various digital imaging formats, such as a JPEG. The images may also be in the form of motion videos, such as MPEG videos, captured by a video camera or time-sequenced photographs that were captured by a digital still camera or a digital video camera.

The images may be retrieved by the client device from a network-connected server that associates each street level image with image data 110. The server may send this image data including the associated street level images to the client device in response to a user request to navigate through a street level view of a location.

As shown in FIG. 1 merely as an illustrative example, the image data 110 may include spatial data, such as a latitude and longitude position 112, indicting a geolocation depicted in the street level image 118. In some aspects, the spatial data may be determined by converting locations identified in accordance with one reference system into locations identified by another reference system. For example, a computing device may convert street addresses into latitude/longitude positions and vice versa.

The image data 110 may also include information indicating a date 114 that the street level image 118 was captured. For example, the date 114 may be retrieved from an internal clock within the image-capturing device used to capture the street level image 118 or it may be determined by a server at a time when the street level image 118 are presented for storage. The date 114 can be associated with the street level image to indicate that the street level image 118 depicts the geolocation on that date.

Using the date of an image only, however, may not be enough to make a user detect the value of navigating through a particular set of imagery. For example, retrieving imagery for “December 2009” regarding Times Square in New York City may not reflect that this imagery was taken at night on New Year's Eve with hundreds of thousands of people at that location. In accordance with the present disclosure, the images can be tagged with a type of label or named time epoch 116, such as “New Year's Eve Celebration,” which represent a time dimension indicating some type of temporally relevant information related to the image. This time epoch 116 can also represent other forms of relevant information, such as different weather and seasonal conditions (e.g., “March 2011 after a snowstorm”). An advantage of using image data in the foregoing manner is that the image data can be used as an index to spatially and temporally rank a discrete set of street level images.

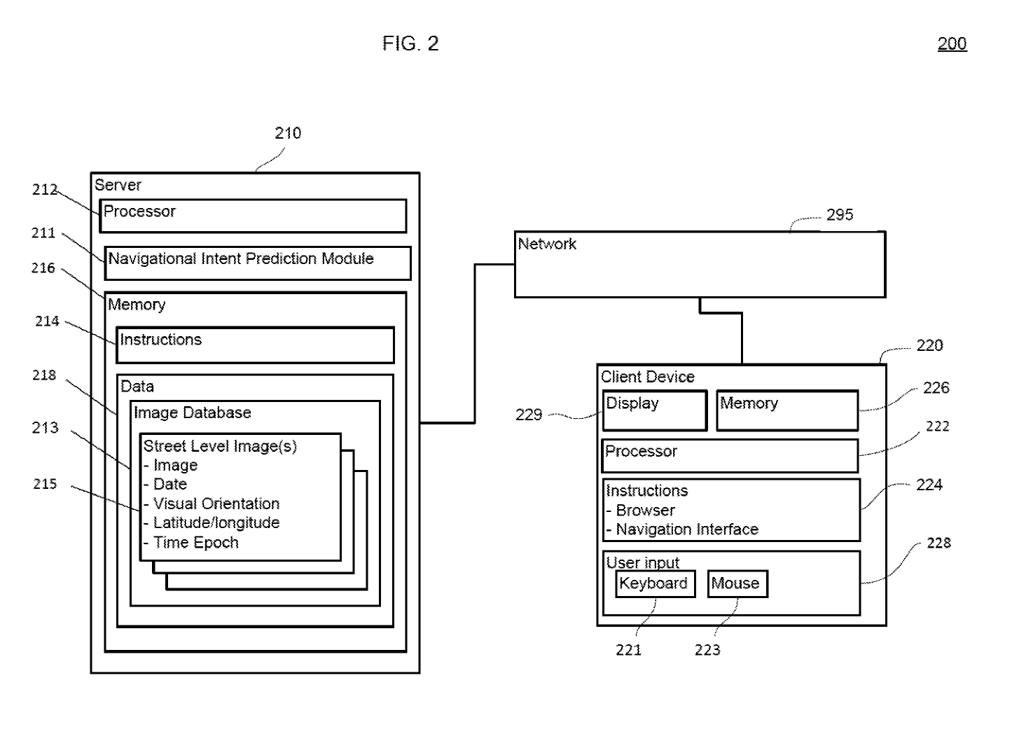

FIG. 2 is a block diagram of a system 200, which may associate spatially and temporally relevant information with a storage of street level images. The system 200 includes a server 210 coupled to a network 295 and one or more client devices 220 (only client device 220 being shown in FIG. 2 for clarity) capable of communicating with the server 210 over the network 295. The server 210 may include a processor 212, memory 216, and other components typically present in general purpose computers.

The memory 216 of server 210 may store information that is accessible by the processor 212, including instructions 214 that may be executed by the processor 212, and data 218. The memory 216 may be of any type of memory operative to store information accessible by the processor 212, including a non-transitory computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The subject matter disclosed herein may include different combinations of the foregoing, whereby different portions of the instructions and data are stored on different types of media.

Although FIG. 2 functionally illustrates the processor 212 and memory 216 as being within the same block, the processor 212 and memory 216 may actually include multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor 212. Similarly, the processor 212 may actually comprise a collection of processors, which may or may not operate in parallel.

Data 218 may be retrieved, stored or modified by processor 212 in accordance with the instructions 214. For instance, although the present disclosure is not limited by any particular data structure, the data 218 may be stored in computer registers, in a relational database as a table having a plurality of different fields and records, XML documents, or flat files. The data 218 may also be formatted in any computer-readable format such as, but not limited to, binary values, ASCII or Unicode. By further way of example only, the data 218 may be stored as bitmaps comprised of pixels that are stored in compressed or uncompressed, or various image formats (e.g., JPEG), vector-based formats (e.g., SVG) or computer instructions for drawing graphics. Moreover, the data 218 may comprise any information sufficient to identify the relevant information, such as numbers, descriptive text, proprietary codes, pointers, references to data stored in other memories (including other network locations) or information that is used by a function to calculate the relevant data.

A typical system can include a large number of connected computers, with each different computer being at a different node of the network 295. The network 295, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

The client device 220 may be configured similarly to the server 210, with a processor 222, memory 226, instructions 224, and all of the internal components normally found in a personal computer. By way of example only, the client device 220 may include a central processing unit (CPU), display device 229 (for example, a monitor having a screen, a projector, a touch-screen, a small LCD screen, a television, or another device such as an electrical device that is operable to display information processed by the processor 222), CD-ROM, hard-drive, user input 228 (for example, a keyboard 221, mouse 223, touch-screen or microphone), speakers, modem and/or network interface device (telephone, cable or otherwise) and all of the components used for connecting these elements to one another.

The client device 220 may be a computing device. For example, client device 220 may be a laptop computer, a netbook, a desktop computer, and a portable personal computer such as a wireless-enabled PDA, a tablet PC or another type of computing device capable of obtaining information via a network like the Internet. Although aspects of the disclosure generally relate to a single client device 220, the client device 220 may be implemented as multiple devices with both portable and non-portable components (e.g., software executing on a rack-mounted server with an interface for gathering location information).

Although the client devices 220 may include a full-sized personal computer, the subject matter of the present disclosure may also be used in connection with mobile devices capable of wirelessly exchanging data. For example, client device 220 may be a wireless-enabled mobile device, such as a Smartphone, or an Internet-capable cellular phone. In either regard, the user may input information using a small keyboard, a keypad, a touch screen or other means of user input. In various aspects, the client devices and computers described herein may comprise any device capable of processing instructions and transmitting data to and from humans and other devices and computers including general purpose computers, network computers lacking local storage capability, game consoles, and set-top boxes for televisions.

The client device 220 may include a component, such as circuits, to determine the geographic location of the device. For example, the client device 220 may include a GPS receiver (not shown). By way of example only, the component may include software for determining the position of the device based on other signals received at the client device 220, such as signals received at a cell phone's antenna from one or more cell phone towers if the mobile device is a cell phone. In that regard, the provision of location identification data may occur automatically based on information received from such a component.

The instructions 224 of the client device 220 may be a set of instructions to be executed directly (such as machine code) or indirectly (such as scripts) by the processor. In that regard, the terms “instructions,” “steps” and “programs” may be used interchangeably herein. The instructions 224 may be stored in object code format for direct processing by the processor, or in any other computer language including scripts or collections of independent source code modules that are interpreted on demand or compiled in advance. Functions, methods and routines of the instructions are explained in more detail below.

The instructions 224 may include a browser for displaying network data, and a navigation interface module to allow a user of the client device 220 to interactively navigate over the display of data. The browser provides for the display of network content, such as street level images, a set of search results or any other type of network data, to a user of the client device 120 by sending and receiving data across the network 195. The network data may be received in response to a search query that includes a search key and indication of a geographic location. The search results returned are associated with locations within the geographic region. For example, the search results can be a number of street level images of different buildings or landscapes within the geographic region.

Each street level image may include an image, date, a visual orientation of the image as well as other relevant information (e.g., metadata) that can be stored. For example, image database 213 of sever 210 may store street level images 215, which may be transmitted to client device 220. The street level images 218 may include images of objects at geographic locations, such as buildings, streets, and regional terrains. The images are typically captured by cameras at the geographic locations from a perspective a few feet above the ground. In many aspects, a typical street level image may include as many geographic objects (street lights, mountains, trees, bodies of water, vehicles, people, etc.) in as much detail as a camera can possibly capture.

The street level images 215 can include information relevant to the location of an image. For example, the street level images 215 may store latitude/longitude positions representing locations where the images were captured. Although the subject matter disclosed herein is not limited to a particular positional reference system, it may particularly advantageous to use latitude/longitude positions when referencing a point on the Earth. Accordingly, for ease of understanding and not by limitation, locations of the street level images 215 of system 200 are expressed as latitude/longitude positions.

The street level images 215 can also include information representing a time dimension that describes some time specific semantic knowledge about an image. For example, each street level image may include a time epoch label indicating distinctive features of the street level images 215 related to a given time period. The time epoch labels may represent information, for example, related to different weather and seasonal conditions, certain events and celebrations, or other meaningful information depicted in the street level images 215. This semantic knowledge may be determined, for example, by using a processor to perform imagery analysis on the street level images 215. The imagery analysis may determine whether the images contain particular visual features or markers related to the specific time period. In other situations, a user or system administrator may update the time epoch labels associated with the street level images 215. For example, the images can be sent to a system administrator that may prompt the users to manually input the time epoch labels before the images are stored.

In one aspect, the system 200 may perform a search query for street level images 215 in response to a user request. For example, the user may enter a search query for street level images using the browser of client device 220. In response to the search query, street level images 215 associated with a geographic location are returned. The user may view these street level images 215, for example, on the display 229 of client device 220. Although the images retuned by the server 210 may accurately depict the geolocation, the users may want to navigate back and forward through images of the geolocation from a specific time period. Aspects of system 200 can be configured to predict this user navigational intent.

In order to facilitate the navigational prediction operations of system 200, the server 210 may further include a navigational intent prediction module 211. The functionally of this module can exist in a fewer or greater number of modules than what is shown, with such modules residing at one or more computing devices, which may be geographically dispersed. The prediction module 211 may be operable in conjunction with the server 210 from which it may receive a number of signals indicating the user's navigational intent.

In one example, a search query may include signals indicating a user's navigational intent. For example, a user search query for “Vermont ski resorts” may indicate that the user does not just want images of where these resorts are located, but rather specific imagery taken during the winter months. In response, the prediction module 211 may determine that street level images return by server 210 should not include the most recent imagery, but the most contextually relevant imagery (e.g., images from January). Similarly, if the search query included “Vermont mountain biking,” the prediction module 211 may determine that imagery from the summer should be returned by the server 210.

Other types of signals indicating a user's navigational intent may include, information about the user such as their current location (e.g., GPS location of the user's client device) or navigation history. For example, if a user's navigation history discloses that the user has been searching for cold weather type items like ski boots, this may also indicate that the user wants specific imagery that corresponds to winter months. The navigation history may represent data collected using the browser of client device 220. The client navigation history may be maintained on the client device 210 or on a remote server, such as server 210, and provided to the prediction module 214 to facilitate predicting the user's navigational intent.

As discussed above, users may be provided with an opportunity to control whether programs or features of the present disclosure may collect user information or to control whether and/or how to receive content that may be more relevant to the user. Certain data may also be treated in one or more ways before it is stored or used, so that personally identifiable information is removed.

In addition to information about the user, specific knowledge about historical events that occurred at a geolocation can serve as a signal. For example, a search query for “ground zero nyc” may indicate that the user is interested in images regarding a time period corresponding to the history of the World Trade Center site more than just a simply street address in lower Manhattan.

In response to various user requests, the server 210 may find one or more images associated with a specific geolocation. For example, the results for the search queries “Vermont ski resorts” and “Vermont mountain biking” may refer to images of the same physical geolocation from different time periods where the ski resorts may also have mountain biking in the summer. In that regard, the user may be provided with an identification of available time periods for which images are available for the geolocation. For example, a user interface or a type of thumbnail on the display 229 of the client device 220 may indicate that images captured at different times can be viewed for a specific geolocation. The street level images and/or associated image data can be transmitted from the server 210 to the client device 220 for use in the user interface/thumbnails.

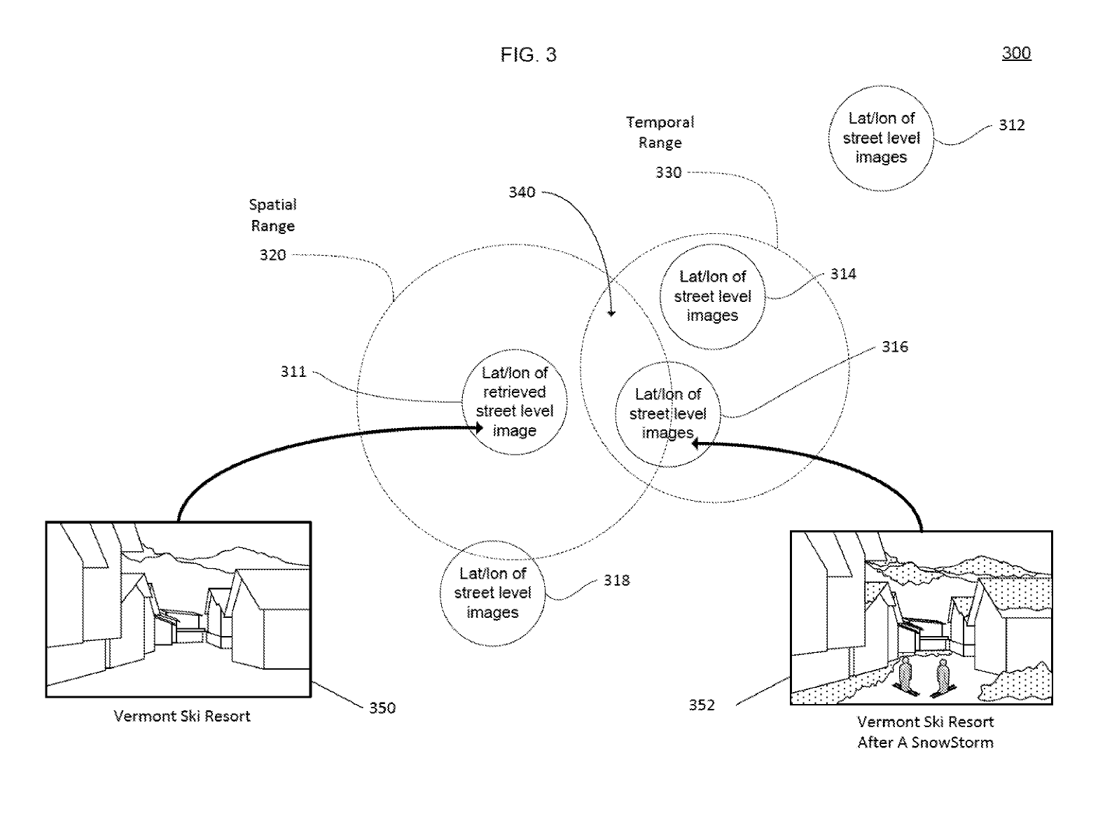

In other aspects, when the server 210 finds one or more images associated with a geolocation, it may determine which images are in line with the user's navigational intent. For example, based on a user's predicted navigational intent, system 200 may automatically time-shift to images aligning more with the imagery from a specific time period that the user intended to navigate through. When selecting these images, the system 200 may estimate an approximate latitude/longitude position in the geolocation in response to a user request. It may select one or more images from a set of known images based on whether their locations are within a proximate spatial range to the estimated position and whether the images are within a proximate second range (e.g., a temporal range representing a time dimension) identified by the user's predicted navigational intent. This time-shifting selection technique is further described below with respect to FIG. 3.

FIG. 3 is a functional diagram 300 of a location of a street level image 311 and locations other street level images 312-318 within varying ranges, for example, images within a spatial range 320 and an identified temporal range 330. As shown in FIG. 3, a street level image 350 may be associated with a geolocation (e.g., Vermont Ski Resort). A server, such as server 210 described with respect to FIG. 2, may have retrieved the image based on a user request to navigate thorough images of a geolocation. In response, the server determines the location of the street level image 311, for example, based on a latitude/longitude position that may be associated with the image.

The server may query an image database for similar street level images having locations that are within a predefined spatial range 320 of street level image 350, such as all images within a given spatial threshold expressed in a unit of measurement (e.g., inches, feet or meters). For example, the server may select the closest set of street level images 318 and 316 to the latitude/longitude location of bubble 311. The selected images in these bubbles may share relevant visual data, such as the images may view a geolocation from a similar angel, orientation or evaluation level. The visual similarities between the images may be verified, for example, based on a visual analysis of the street level images. This visual analysis may look for corresponding features from the images that match in shape, position or orientation, or by comparing image data associated with each image. Although other street level images 314 and 312 are not selected because they may not be within range, the spatial range 320 can be expended to include other images if no comparable images are found in the initial specified range.

After spatial similar images are selected, the set of available imagery may be further refined based on the predicted navigational intent. For example, based on a number of signals, the server can determine a number of street level images related to the geolocation from a specific time period (e.g., winter images). For example, in response to the predicted navigational intent, the server may identify street level images from within temporal range 330. The images within this range (e.g., bubbles 314 and 316) may depict a geolocation at a specific time period, such as street level image 352 which depicts the Vermont ski resort after a snowstorm.

To ensure that images displayed to the user spanning different time periods visual correspond as closely as possible to each other, the server may select street level images located within an overlap area 340 between ranges 320 and 330. This overlap area 340 may contain images that not only are aligned with the user's predicted navigational intent, but are also geographically similar to the location 311 of street level image 350. An advantage of this type of selection technique is that the server may minimize the number of visual artifacts that can occur between images displayed to the user.

There are situations when a user may want to see several street level images depicting conditions at a geolocation over a span of time. For example, the user may want to time navigate back and forward through the street level images as if watching a time-lapse video of the location. To facilitate the time navigation features of the present disclosure, the user may be provided with a variety of different indicators of available time periods for which geolocated street level images are available.

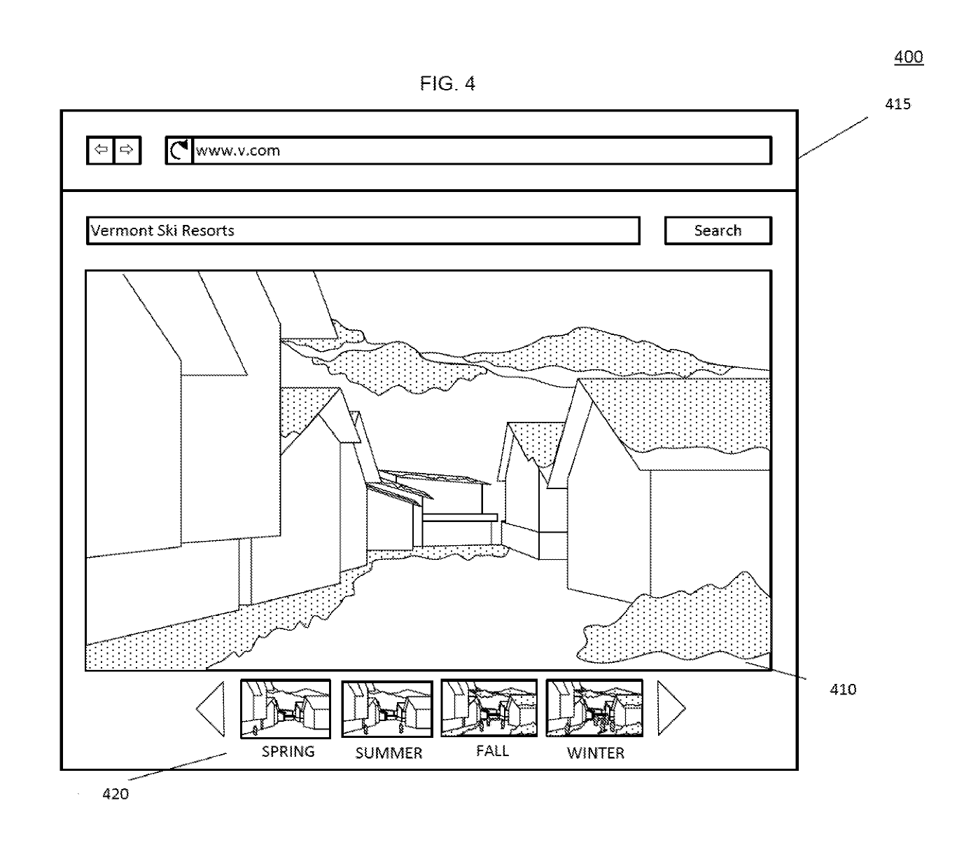

FIG. 4 is an illustration 400 of a street level image 410 including an example of an interface 420. The interface 420 may provide a user with access to available imagery of a geographical location that spans space and time. The interface 420 may be flexibly configured to include various types of buttons, cursors, and tools as well as formatted image content on a display. As shown in FIG. 4 merely as an illustrative example, one type interface 420 can be a series of thumbnails on a browser 415.

The thumbnails may comprise, for example, an actual street level image, a modified version of the image, content related to the image, a network location (e.g., a Uniform Resource Locator), or other information which can be used to retrieve the street level image. As shown in FIG. 4, each thumbnail may indicate a time dimension, such as one of the four seasonal divisions of the year (e.g., spring, summer, fall, and winter). Upon selection of a thumbnail, the corresponding street level image can be displayed. In one embodiment, the images may be displayed one at a time in rapid succession. For example, the interface 420 may include a toggle button or another type of navigational service that allows a user to indicate their intent to successively navigate through the geolocated imagery as though traveling back or forward through the time dimension.

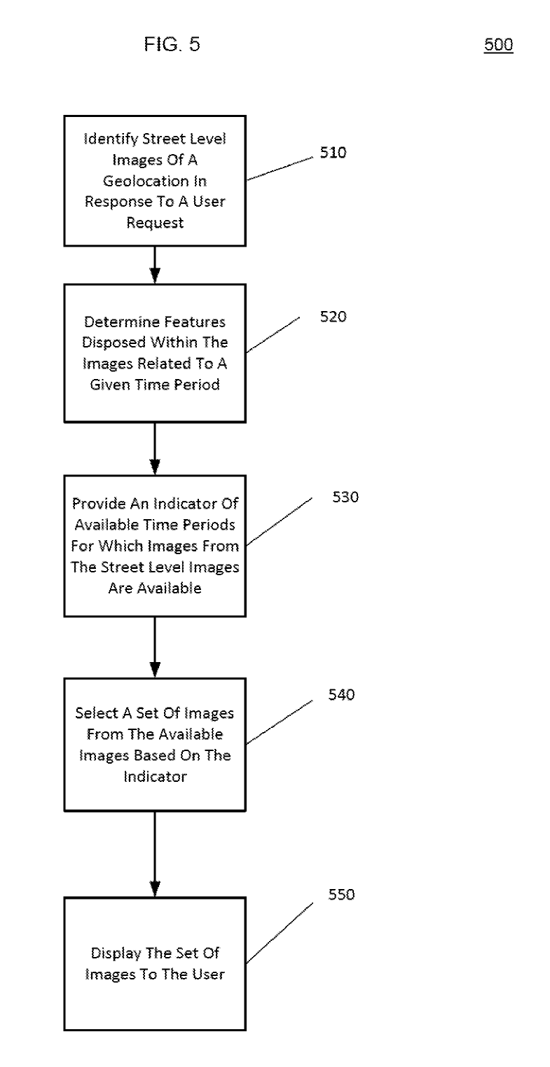

An example of a method 500 incorporating such navigational services is presented in FIG. 5.

In block 510, a number of street level images of a geolocation are identified in response to a user request. For example, a system may receive a request for street level imagery from a client device. The user may enter a search query for street level images using the client device. In response to the search query request, street level images associated with a geographic location are returned. The street level images are stored in an image database coupled to the system. These images may depict a street level view of a real-world geographic location.

In block 520, features disposed within the images related to a given time period may be determined. For example, each street level image may be associated with a label indicating distinctive features within the images. The labels may represent a time dimension indicating information related to different weather and seasonal conditions, certain events and celebrations, or other meaningful information depicted in the street level images at a specific moment in time. This semantic knowledge of the images may be determined, for example, by using a processor to perform imagery analysis on the street level images to look for particular visual features or markers related to a specific time period.

In block 530, an indicator of available time periods for which images of the street level image are available may be provided. For example, a user interface on a display of a client device may indicate that images captured at different times can be viewed for a specific geolocation. In one example, the available time periods may be displayed on a client device as four natural divisions of the year, spring, summer, fall, and winter.

In block 540, a set of images from the available images can be selected based on the indicator. Based on the indicator of available time periods, the user may make a selection of a set of the images to navigate through. For example, the user interface described in block 530 may be flexibly configured to include various types of buttons, thumbnails, cursors, street level images or a network URL, which can be used to retrieve the street level image when activated. Upon a user activating, for example, a thumbnail or button on the interface, a corresponding set of street level images can be retrieved from a database.

In block 550, the set of images are displayed to the user. For example, the selected set of street level images from block 540 may be displayed on the user's client device. The display of images can occur one at a time or in rapid succession so as to simulate a time-lapse video. For example, the user interface may include a toggle button that allows a user to indicate their intent to successively navigate through the geolocated street level imagery.

Another aspect of the subject matter disclosed herein pertains to predicting a user's intent to navigate through geolocated imagery from a specific time period. As noted above with respect to FIG. 2, a computing device may include an application software module to facilitate aspects of the navigational prediction operations.

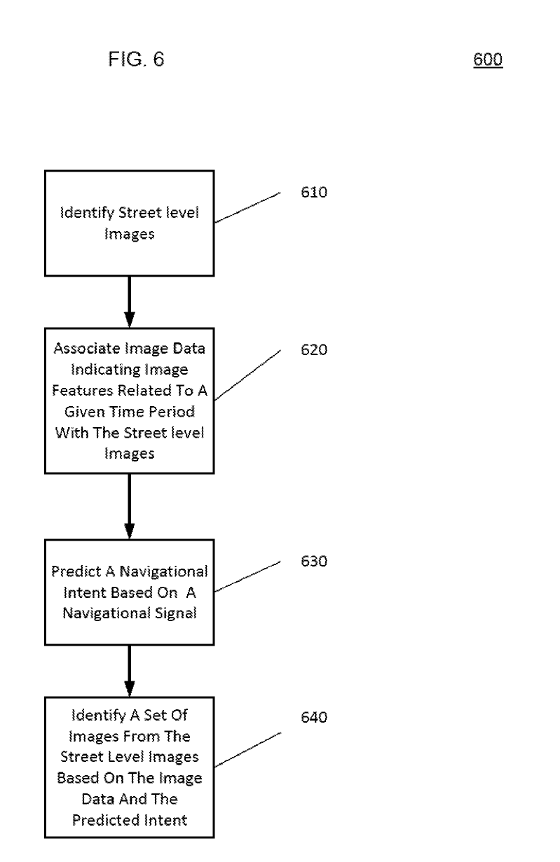

An example of a method 600 for predicting a navigational intent is presented in FIG. 6.

In block 610, a number of street level images are identified. For example, the street level images may be identified from different sources and may include photographs and videos of buildings, surrounding neighborhoods, and other terrains. The images are captured at the geographical locations over a span of time. These images may be stored in a database coupled to a computing device.

In block 620, image data including information representing a time dimension may be associated with the street level images. The time dimension data may indicate visual features of an image related to a given time period. This temporally relevant information can be included with each street level image. For example, the image data may comprise a label indicating distinctive time features of the street level images related to a time period (e.g., weather conditions or celebratory events). A database may store the image data along with the corresponding street level images. A portion of these stored images may be selected based on a user's intent to navigate through a street level view of the geolocation.

In block 630, a navigational intent of a user may be predicted based on the image data and a navigational signal. The navigational signal may include information about the user such as their current location or navigation history, or information about a specific location for which street level images are requested. In one example, the user's intent can be predicted based on a web browser search query. For example, the search query may include navigational signals indicating that the user wants to view images of a geographical location at a particular point in time. The time navigational signals can include, for example, a description or historical reference in a search string for a geographical location or information indicating that the user wants to see images depicting conditions at a geolocation during a specific period of time.

In block 640, a set of images from the street level images can be identified based on the image data and the predicted user intent. In response to a user request for street level images of a geolocation, a computing device may estimate a position of that location. It may select a set of images from street level images the stored in block 610 based on whether a location of the images falls within a predetermined spatial range from the estimate position. This location information can be retrieved from image data.

After spatial similar images are selected, the set of imagery may be further paired down based on the predicted navigational intent. For example, based on the predicted navigational intent, the computing device can determine that the user wants to navigate through images of the geolocation from a specific time period (e.g., winter images). The computing device may identify a sub set of street level images having visual features corresponding to the user's predicted navigational intent. For example, the computing device may select images where their associated image data indicates that images are from the same time period. These selected images may allow the user to navigate through images depicting conditions at a geolocation during the desired period of time.

The above-described aspects of the present disclosure may be advantageous for navigating through geolocated imagery that spans space and time. Aspects of the disclosure may determine a user's intent to move back or forward through a time dimension regarding images of a real-world space. This may allow the user to time-navigate over images of a specific scene in a real-world space or as closely as possible to the scene so that the user can see how the scene has changed over time. Moreover, by defining the user's intent to navigate over a time dimension relevant to a set of street level images of a real-world location, desirable intuitive functionality can be provided to a navigational user interface as well as optimize the set of available images required of a real-world time-space coordinate. While aspects of the disclosure are discussed in connection with street-level imagery, the techniques described herein can be used with other types of imagery such as aerial imagery or indoor imagery.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A method, comprising:
identifying a plurality of images depicting a geographic location at street level, wherein the plurality of images are captured at the geographic location over a span of time;
associating, using a processor, image data with the plurality of images, the image data including information representing positional data and a time dimension related to the plurality of images;
predicting, using the processor, a user's navigational intent to move back and forward through the time dimension based on a navigational signal being at least one of: a search query performed by the user, a current location of the user or the user's search history; and
selecting a set of images from the plurality of images based on the image data and the predicted navigational intent, the set of images depicting conditions at the geolocation for one or more time periods.

2. The method of claim 1, wherein the positional data associated with the set of images overlap with each other.

3. The method of claim 1, further comprising providing, to a display of a client device, an indicator of available time periods for which images from the set of images are available for the geographic location.

4. The method of claim 2, further comprising:
receiving a request for images associated with the geographic location for at least one of the available time periods; and
in response to the request, providing the images for the available time periods to the client device for display.

5. The method of claim 1, wherein associating a time dimension with the plurality of images comprises identifying visual features disposed in the plurality of images related to a given time period.

6. The method of claim 1, wherein the navigational signal is performing a search query for a second geographic location.

7. The method of claim 6, further comprising determining historical information related to an event that occurred at the second geographic location, wherein the event occurred at a time corresponding to the one or more time periods associated with the set of images.

8. The method of claim 1, wherein the navigational signal is determining a user's search history including information indicating items related to a given time period that corresponds to the one or more time periods associated with the set of images.

9. The method of claim 1, wherein the navigational signal identifies a current location of a user, the current location of a user corresponding to the positional data associated with the set of images.

10. A non-transitory computer readable medium comprising instructions that, when executed by a processor, cause the processor to perform a method, the method comprising:
identifying a plurality of images depicting a geographical location at street level, wherein the plurality of images are captured at the geographical location over a span of time;
associating, using a processor, image data with the plurality of images, the image data including information representing positional data and a time dimension related to the plurality of images;
predicting, using the processor, a user's navigational intent to move back and forward through the time dimension based on a navigational signal being at least one of: a search query performed by the user, a current location of the user or the user's search history; and
selecting a set of images from the plurality of images based on the image data and the predicted navigational intent, the set of images depicting conditions at the geolocation for one or more time periods.

11. The non-transitory computer readable medium of claim 10, wherein the method further comprising providing, to a display of a client device, an indicator of available time periods for which images from the set of images are available for the geographical location.

12. A system, comprising:
a memory for storing images and image data; and
a processor coupled to the memory, the processor being configured to:
identify a plurality of images depicting a geographical location at street level, wherein the plurality of images are captured at the geographical location over a span of time;
associate image data with the plurality of images, the image data including information representing positional data and a time dimension related to the plurality of images;
predict a user's navigational intent to move back and forward through the time dimension based on a navigational signal being at least one of: a search query performed by the user, a current location of the user or the user's search history; and
select a set of images from the plurality of images based on the image data and the predicted navigational intent, the set of images depicting conditions at the geolocation for one or more time periods.

13. The system of claim 12, wherein the positional data associated with the set of images overlap with each other.

14. The system of claim 12, wherein the processor is further configured to provide to a display of a client device an indicator of available time periods for which images from the set of images are available for the geographical location.

15. The system of claim 14, wherein the processor is further configured to:
receive a request for images associated with the geographical location for at least one of the available time periods; and
in response to the request, the processor is further configured to provide the images for the available time periods to the client device for display.

16. The system of claim 12, wherein to associate a time dimension with the plurality of images the processor is further configured to identify visual features disposed in the plurality of images related to a given time period.

17. The system of claim 1, wherein the navigational signal is performing a search query for a second geographic location.

18. The system of claim 17, wherein the processor is further configured to determine information related to a historical event that occurred at the second geographic location at a time corresponding to the one or more time periods associated with the set of images.

19. The system of claim 12, wherein the navigational signal is determining a user's search history including information indicating items related to a given time period that corresponds to the one or more time periods associated with the set of images.

20. The system of claim 18, wherein the navigational signal identifies a current location of a user, the current location of a user corresponding to the positional data associated with the set of images.
